(19) United States
(12) Patent Application Publication
(10) Pub. No.: US 2005/0180718 A1
(43) Pub. Date: Aug. 18, 2005

(54) Optical member for gathering light

(76) Inventor: Chun-I Hsiao, Hsinchu (TW)

Correspondence Address: BIRCH STEWART KOLASCH & BIRCH, PO BOX 747, FALLS CHURCH, VA, 22040-0747, US

(21) Appl. No.: 10/777,762

(22) Filed: Feb. 13, 2004

(51) Int. Cl. G02B 6/10

(52) U.S. Cl. 385/146

(57) ABSTRACT

An optical member for gathering light sets on one side of a light source of a plane image input device which places documents on. The optical member for gathering light comprises a body that includes an incident surface closed to the side of the light source, a first reflecting surface, a second reflecting surface, and an emergent surface respect to the documents. When using, the side of the light source emits light into the body through the incident surface. Then light processes total internal reflection through the first and the second reflecting surface inside the body. Finally, light emerges to the documents. So light emits from the side and from the other side of the light source of the plane image input device both can be used to improve the brightness of the documents and to improve the scanning efficiency when the plane image inputting instruction in high running speed.

### FIELD OF THE INVENTION

The invention relates to an optical member for gathering light adopted for use on a plane image input device and particularly to an optical member capable of increasing utilization of light emitted from a light source in a plane image input device.

### BACKGROUND OF THE INVENTION

These days digitized information, besides pictures, video signals, multimedia and computer presentations, has been widely used in business documents. While the paperless office is still not fully materialized, the scanning process has played an important role in business electronic information to reduce paper consumption.

The scanner has always been a desirable and popular input device. It is easy to use. Once the lid of the scanner is lifted and opened, a document may be loaded on the glass, and the lid may be closed. Then other scanning operations of the scanning module may be controlled by software.

The principle of a scanner is to use a mechanical or electronic scanning module to read the image pixels on a document and transform the pixels to digital formats. It uses a light source to project light on the document and transforms the reflecting bright spots of the scanned pixels. Therefore it is also called ‘photoelectric transformation’. During the image signal transformation process of the image sensor reading the document, light emitted from the light source is projecting onto the surface of the document. The document surface reflects the light to a lens to form an image and project to a sensor element. Then a proportional output voltage is generated through photoelectric transformation according to image concentration.

Refer to FIG. 1 for the light source used in a scanning module of a conventional scanner. Mostly only one half of the emitting light is being used. Hence only a portion of the light emitted from the light source is being projected onto the document. It is difficult to increase the brightness of the document. When the scanner operates at high speed, scanning efficiency cannot be increased as desired. Besides the scanner, other plane image input devices, such as printers, also have the same problem.

### SUMMARY OF THE INVENTION

Therefore the primary object of the invention is to provide an optical member for gathering light to fully utilize the light emitted from the light source of a plane image input device, to increase the brightness of the document and increase scanning efficiency at high speed operation.

The optical member for gathering light according to the invention is located on one side of the light source of a plane image input device. The plane image input device is loaded with a document on a glass at an upper side. The optical member for gathering light includes a body, which has an incident surface, a first reflecting surface, a second reflecting surface and an emergent surface. The first reflecting surface is connected to the second reflecting surface at about 90 degrees. The incident surface is close to one side of the light source. The emergent surface corresponds to the document.

When in use, one side of the light source emits light, which enters the body from the incident surface and forms a total reflection inside the body. Namely the light projects directly onto the first reflecting surface and is reflected to the second reflecting surface which further reflects the light to the emergent surface in order to project onto the document. Hence the light on one side of the light source and the light on another side of the light source may be used together so that the light emitted from the light source is fully utilized. Therefore the brightness of the document can increase, and the scanning efficiency of the plane image input device can increase at high-speed operation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary schematic view of a conventional scanner.

FIG. 2 is a schematic view of the invention.

FIG. 3 is a schematic view of the invention in use.

FIG. 4 is a schematic view of the invention installed in a plane image input device.

FIG. 5 is a schematic view of the invention installed in a plane image input device showing light travelling paths.

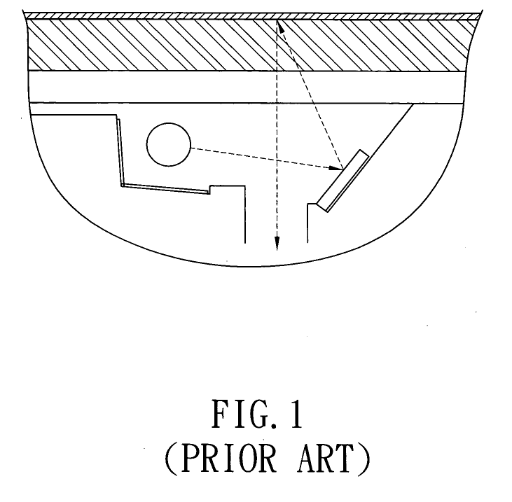

### DESCRIPTION OF THE PREFERRED EMBODIMENTS

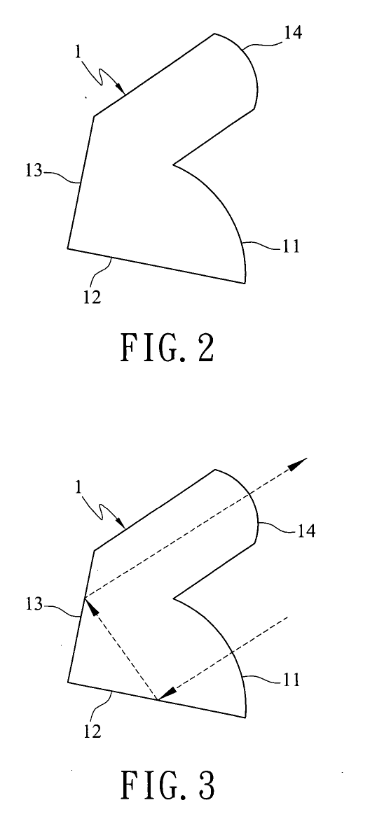

Referring to FIG. 2, the optical member for gathering light according to the invention includes a body 1 which has an incident surface 11, a first reflecting surface 12, a second reflecting surface 13 and an emergent surface 14. The first reflecting surface 12 is connected to the second reflecting surface 13 at about 90 degrees.

Referring to FIG. 3, when in use, light enters the body 1 from the incident surface 11 and reaches the first reflecting surface 12 to be reflected to the second reflecting surface 13, then is reflected to the emergent surface 14. By means of the invention, light may be directed from one location to another location.

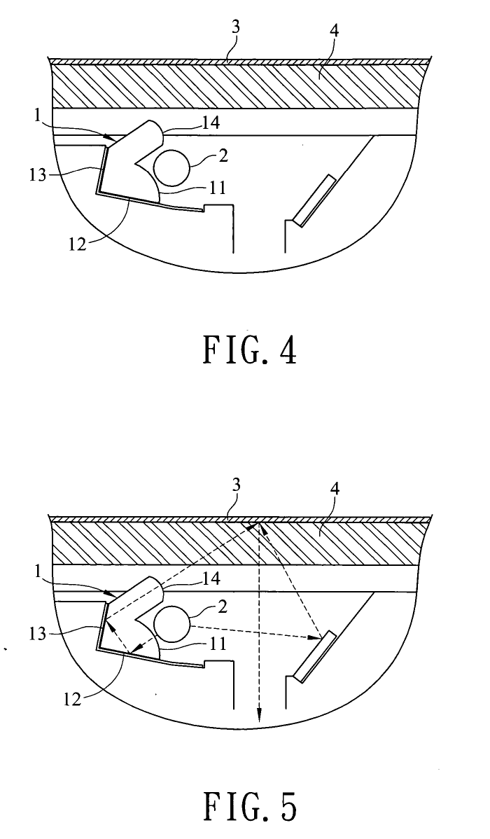

Refer to FIG. 4 for a schematic view of the invention installed in a plane image input device. The optical member for gathering light according to the invention is located on one side of a light source 2. The plane image input device has a glass 4 located on an upper side for being loaded with a document 3. Of course, as previously discussed, the optical member for gathering light of the invention includes a body 1 which has an incident surface 11, a first reflecting surface 12, a second reflecting surface 13 and an emergent surface 14. The first reflecting surface 12 is connected to the second reflecting surface 13 at about 90 degrees. The incident surface 11 is closed to one side of a light source 2, while the emergent surface 14 corresponds to the document 3.

Refer to FIG. 5 for a schematic view of the invention installed in a plane image input device showing light travelling paths. Light emitted from one side of the light source 2 enters the body 1 from the incident surface 11, then travels in the body 1 to form a total reflection. Namely, the light projects directly onto the first reflecting surface 12 and is reflected to the second reflecting surface 13 which further reflects the light to the emergent surface 14 in order to project onto the document 3. Hence the light on one side of the light source 2 and the light on another side of the light source 2 can be used together, so that the light emitted from the light source 2 is fully utilized. Therefore the brightness of the document 3 can increase, and the scanning efficiency of the plane image input device can increase at high speed operation.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. An optical member for gathering light, which is located on one side of a light source of a plane image input device, the plane image input device being loaded with a document, the optical member comprising a body which has an incident surface, a first reflecting surface, a second reflecting surface and an emergent surface, wherein light emitted from the light source on the one side enters the body from the incident surface, forms a total reflection through the first reflecting surface and the second reflecting surface and passes through the emergent surface in order to project onto the document.

2. The optical member for gathering light of claim 1, wherein the incident surface is close to the one side of the light source, and the emergent surface corresponds to the document, so that the light emitted from the light source on the one side enters the body from the incident surface, forms a total reflection inside the body and passes through the emergent surface in order to project onto the document.

3. The optical member for gathering light of claim 1, wherein the first reflecting surface is connected to the second reflecting surface at about 90 degrees.
